(19) United States
(12) Patent Application Publication
(10) Pub. No.: US 2008/0296548 A1
(43) Pub. Date: Dec. 4, 2008

(54) PANEL CONNECTION SYSTEM

(76) Inventor: John McDonald, Solomon, KS (US)

Correspondence Address: HUSCH BLACKWELL SANDERS LLP, 4801 Main Street, Suite 1000, KANSAS CITY, MO, 64112, US

(21) Appl. No.: 11/756,343

(22) Filed: May 31, 2007

(51) Int. Cl. A01K 3/00

(52) U.S. Cl. 256/26; 119/514

(57) ABSTRACT

A panel connection system is provided that includes a connection assembly having a sleeve and two connecting members that is pivotally coupled to a panel end post, another connection assembly having a connecting member, and a means for pivotally coupling the connecting members of the two connection assemblies.

### CROSS-REFERENCE TO RELATED APPLICATIONS

None.

### BACKGROUND OF THE INVENTION

Portable, foldable corral systems and portable panels are widely used to create temporary holding areas for confining livestock and the like. Livestock and the like are often gathered in confined holding areas so that they can be doctored or moved to another location via a truck or trailer. Generally, portable, foldable corral systems are made up of a series of interconnected panels.

In cases where panels are part of a portable, foldable corral system, it is desirable to fold one panel back flat against another panel such that the two become parallel with one another for compactness during transport. Also, in cases where a panel is being used as a gate, whether in a portable corral system or otherwise, it is desirable to fold the panel back flat against another panel such that the two become parallel with one another. However, with many conventional panel connection systems, when a user attempts to fold one panel back flat against another panel, the two panels will come into interference and obstruct each other before ever becoming parallel to one another.

This interference is undesirable because, in addition to preventing the panels from being folded back flat against one another, it also can put excessive stress on the panels and their connection systems to the point of causing bending and/or premature weld failure. Further, using a panel as a gate that cannot be folded back flat against another panel can lead to situations where livestock are diverted into a V-shaped area created by the two panels instead of through the hole created by the gate's opening.

Many conventional panel connection systems are configured such that they can only secure two panels together. It is often desirable to create corral systems having multiple pens. When doing so, partitions need to be created within the corral system, which involves securing more than two panels together.

Corral systems are often set in environments, such as pastures, that have uneven terrain. When corral systems formed with panels having conventional connection systems are set up on uneven terrain, it can lead to excessive stress being exerted on the panels and their connection systems to the point of causing bending and/or premature weld failure.

### SUMMARY OF THE INVENTION

An embodiment of the present invention is directed towards a panel connection system that includes a first connection assembly having a sleeve that is configured to be pivotally coupled to an end post and a plurality connecting members, a second connection assembly having a connecting member, and a means for pivotally coupling the connecting members of the first connection assembly with the connecting member of the second connection assembly.

Another embodiment of the present invention is directed towards a panel connection system that includes a vertical end post, at least two horizontal panel members attached to the vertical end post, two connection assemblies pivotally coupled to the vertical end post, each having a sleeve and a plurality of connecting members that are configured to be pivotally coupled to the connectors of an adjoining panel.

A further embodiment of the present invention is directed towards a portable panel that includes two end posts, a first connection assembly having a sleeve and a plurality of connecting members that is pivotally coupled to one of the end posts and a second connection assembly having a connecting member that is pivotally coupled to the other end post. The connecting members of the first and second connection assemblies are configured to be pivotally coupled to the connectors of an adjoining panel.

Certain embodiments of the invention are outlined above in order that the detailed description thereof may be better understood, and in order that the present contributions to the art may be better appreciated. In this respect, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### DESCRIPTION OF THE SEVERAL VIEWS OF THE DRAWINGS

Further features of the present invention will become apparent to those skilled in the art to which the present invention relates from reading the following description with reference to the accompanying drawings, in which:

FIG. 1 is a front elevational view of a panel incorporating a panel connection system in accordance with one embodiment of the present invention;

FIG. 2 is a front perspective view of a connection assembly that is part of a panel connection system in accordance with one embodiment of the present invention;

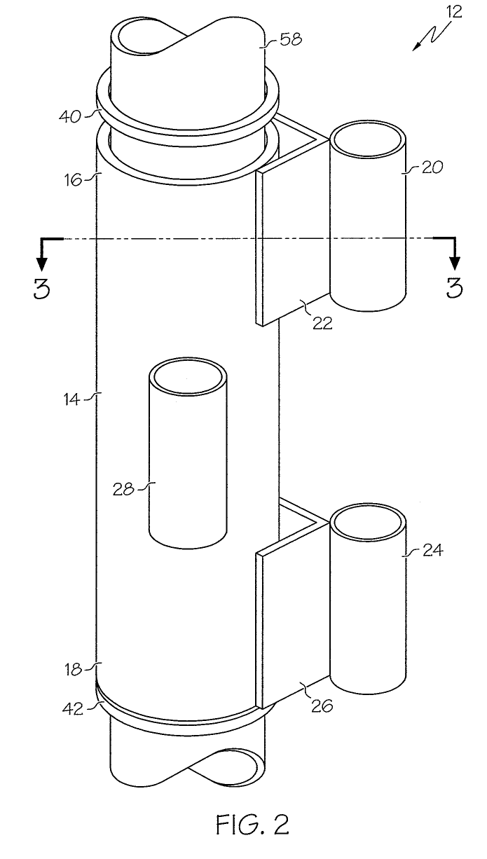

FIG. 3 is a plan cross-sectional view of the connection assembly of FIG. 2;

FIG. 4 is a front perspective view of a connection assembly that is part of a panel connection system in accordance with one embodiment of the present invention;

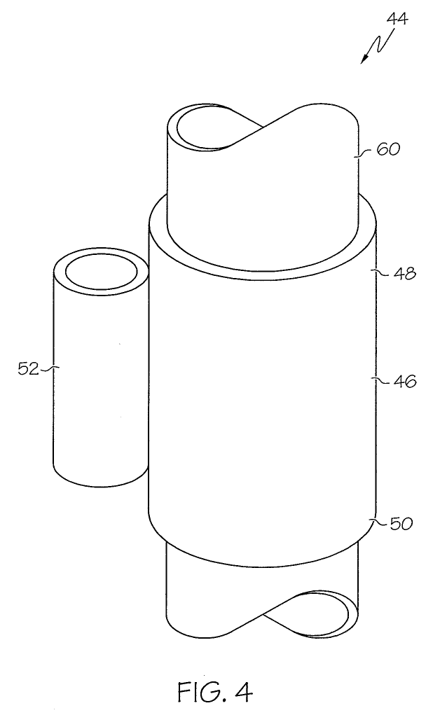

FIG. 5 is a front perspective view of a panel connection system in accordance with one embodiment of the present invention;

FIG. 6 is a front elevational view of a panel incorporating the panel connection system in accordance with another embodiment of the present invention;

FIG. 7 is a front perspective view of a connection assembly that is part of a panel connection system accordance with another embodiment of the present invention;

FIG. 8 is a plan cross-sectional view of the connection assembly of FIG. 7.

FIG. 9 is a front perspective view illustrating the manner in which four panels can be secured together and the manner in which two connected panels can be positioned parallel to one another using the panel connection system in accordance the connection assembly of FIG. 7.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

An embodiment of the present invention is directed to a panel connection system for securing panels together. It will be appreciated by one skilled in the art that the panel connection system can be incorporated with various types of panels, fencing, gates, corral systems, doors, frames, chutes, scaffolding, and other suitable structures.

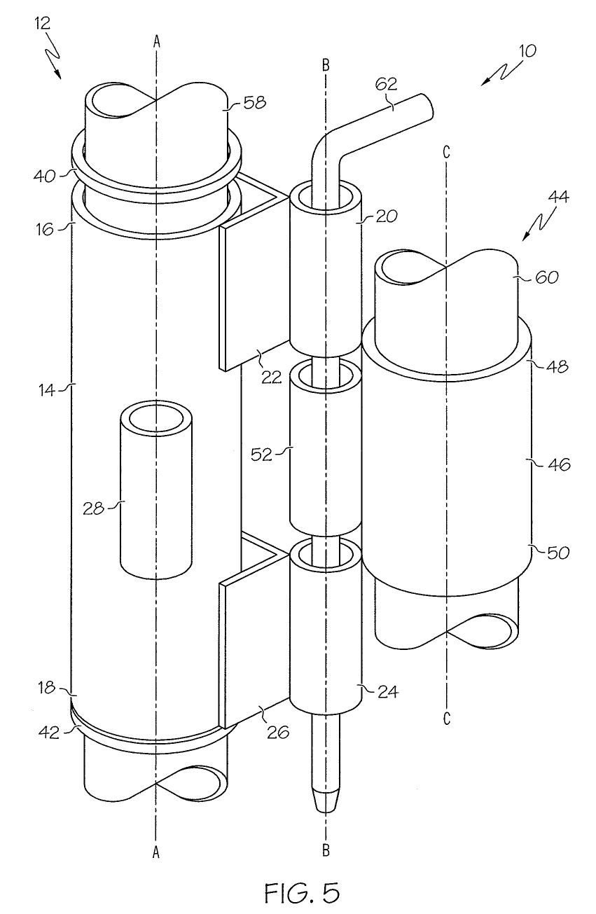

As shown in FIG. 5, panel connection system 10 includes a first connection assembly 12 and a second connection assembly 44. The first connection assembly 12 includes a sleeve 14 having a first end 16 and a second end 18. The sleeve 14 is pivotally coupled to a panel end post 58 about an axis A-A. As shown in FIG. 5, both the sleeve 14 and the panel end post 58 have circular cross-sections. However, other cross-sectional shapes can be used. For example, the sleeve 14 could have a circular cross-section and the panel end post 58 could have a square cross-section while still allowing the sleeve 14 to be pivotally coupled to the panel end post 58. Likewise, the sleeve 14 could have a square cross-section and the panel end post 58 could have a circular cross-section while still allowing the sleeve 14 to be pivotally coupled to the panel end post 58. The sleeve 14 and panel end post 58 can have numerous other cross sectional shapes so long as the sleeve 14 is pivotally coupled to the end post 58.

The first connection assembly 12 has a connecting member 20 located proximate the sleeve first end 16 and a connecting member 24 located proximate the sleeve second end 18. Connecting members 20, 24 are positioned on sleeve 14 to form a clevis-like configuration. As illustrated in FIG. 5, connecting members 20, 24 are configured to receive another connecting member 52 therebetween. The connecting members 20, 24 are substantially aligned with one another about an axis B-B and can be constructed of cylindrical or square hollow tubing such that they can receive a pin 62. In another embodiment, the connecting members 20, 24 are coupled to the sleeve 14 via spacers 22, 26. It will be appreciated by one skilled in the art that the spacers 22, 26 can be L-shaped members constructed from angle iron or the like, however, any suitable material and shape may be used.

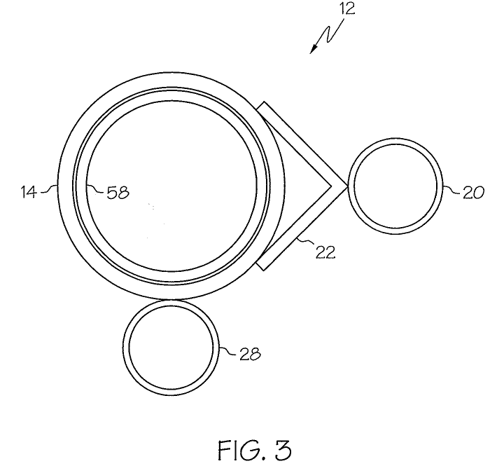

The first connection assembly 12 also includes a connecting member 28 located between the sleeve first and second ends 16, 18. As illustrated in FIG. 3, connecting member 28 is radially offset from connecting members 20, 24. In one embodiment, connecting member 28 is radially offset from connecting members 20, 24 by approximately 90 degrees, as shown in FIG. 3. The combination of the set of connecting members 20, 24 along with connecting member 28 allows the first connection assembly 12 to be simultaneously coupled to two panels, thereby allowing three panels to be secured together at the same time via the first connection assembly 12. Additionally, whenever a user desires to only secure two panels together, the user can rotate the first connection assembly 12, thereby allowing him or her to select between the clevis-like configuration and the single connecting member, depending upon the configuration of the other panel.

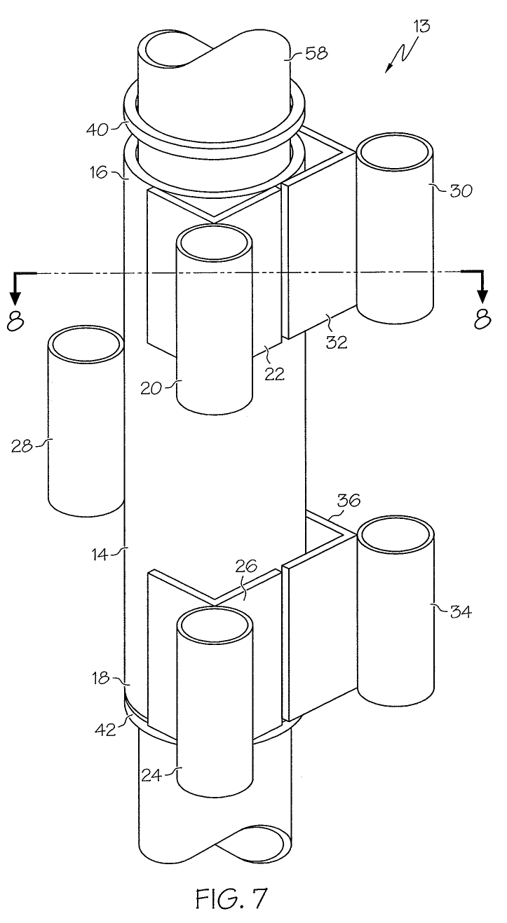

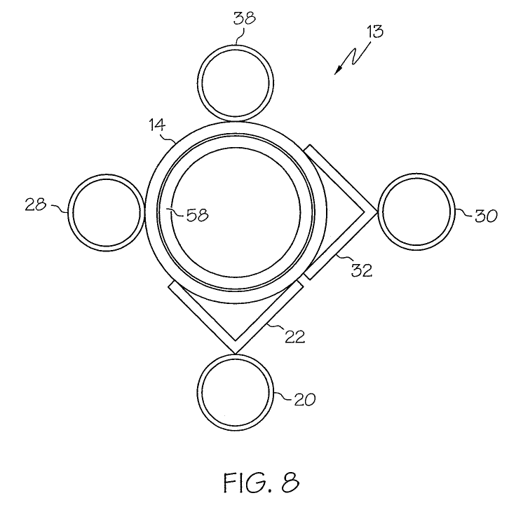

FIGS. 7-8 show another embodiment of a first connection assembly 13 that includes additional connecting members 30, 34, 38. As shown in FIG. 7, the first connection assembly 13 includes an additional set of connecting members 30, 34 that are positioned on sleeve 14 to form another clevis-like configuration. Like connecting members 20, 24, connecting members 30, 34 are configured to receive another connecting member therebetween. They are also aligned with one another and can be constructed of cylindrical or square hollow tubing such that they can receive a pin 62. As shown, connecting members 30, 34 are coupled to the sleeve 14 via spacers 32, 36. It will be appreciate by one skilled in the art that connecting members 30, 34 may also be coupled to the sleeve 14 without spacers. As shown in FIGS. 7-8, connecting members 30, 34 are radially offset from connecting members 20, 24, 28. In one embodiment, connecting members 30, 34 are radially offset from connecting member 28 by approximately 180 degrees.

As shown in FIG. 8, the first connection assembly 13 also includes a connecting member 38 located between the sleeve first and second ends 16, 18. As illustrated in FIG. 8, connecting member 38 is radially offset from connecting members 20, 24, 28, 30, 34. In one embodiment, connecting member 38 is radially offset from connecting members 20, 24 by approximately 180 degrees.

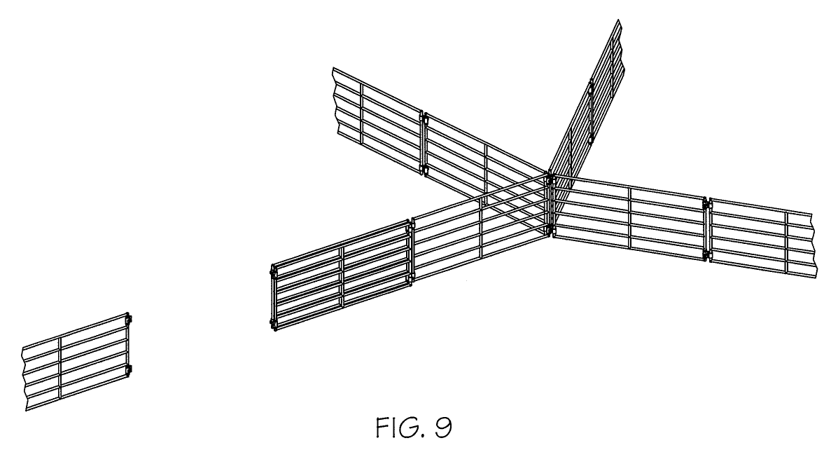

The combination of the set of connecting members 20, 24, the set of connecting members 30, 34, the connecting member 28, and the connecting member 38 allows the first connection assembly 13 to be simultaneously coupled to up to four panels, thereby allowing five panels to be secured together at the same time via the first connection assembly 13. FIG. 9 illustrates how four panels can be secured together using the embodiment of FIGS. 7-8.

As shown, the panel connection system 10 also includes a pair of stops 40, 42. Stops 40, 42 are secured to the end post 58 and restrict the longitudinal movement of the first connection assembly 12. One stop 40 is secured to the end post 58 proximate the sleeve first end 16 and the other stop 42 is secured to the end post 58 proximate the sleeve second end 18. The stops 40, 42 may be selected from the group comprising of bolts, pins, clamps, rings, tabs, combinations thereof, or any other stop suitable for the present invention now known or hereafter developed. The stops 40, 42 shown in FIG. 5 are retaining rings that can be welded to the panel end post 58.

As shown in FIG. 5, the panel connection system 10 also includes a second connection assembly 44. The second connection assembly 44 includes a sleeve 46 having a first end 48 and a second end 50. The sleeve 46 is coupled to a second panel end post 60. The second connection assembly 44 has a connecting member 52 located between the sleeve first and second ends 48, 50. Connecting member 52 can be constructed of cylindrical or square hollow tubing such that it can receive a pin 62.

In one embodiment, the sleeve 46 is fixedly attached to the panel end post 60 such that it does not rotate. In another embodiment, the sleeve 46 is pivotally coupled to the panel end post 60 such that it can rotate about an axis C-C. As shown in FIG. 5, both the sleeve 46 and the panel end post 30 have circular cross-sections. However, other cross-sectional shapes can be used. For example, the sleeve 46 could have a circular cross-section and the panel end post 60 could have a square cross-section while still allowing the sleeve 46 to be pivotally coupled to the panel end post 60. Likewise, the sleeve 46 could have a square cross-section and the panel end post 60 could have a circular cross-section while still allowing the sleeve 46 to be pivotally coupled to the panel end post 60. The sleeve 46 and panel end post 60 can have numerous other cross sectional shapes so long as the sleeve 46 can be pivotally coupled to the end post 60.

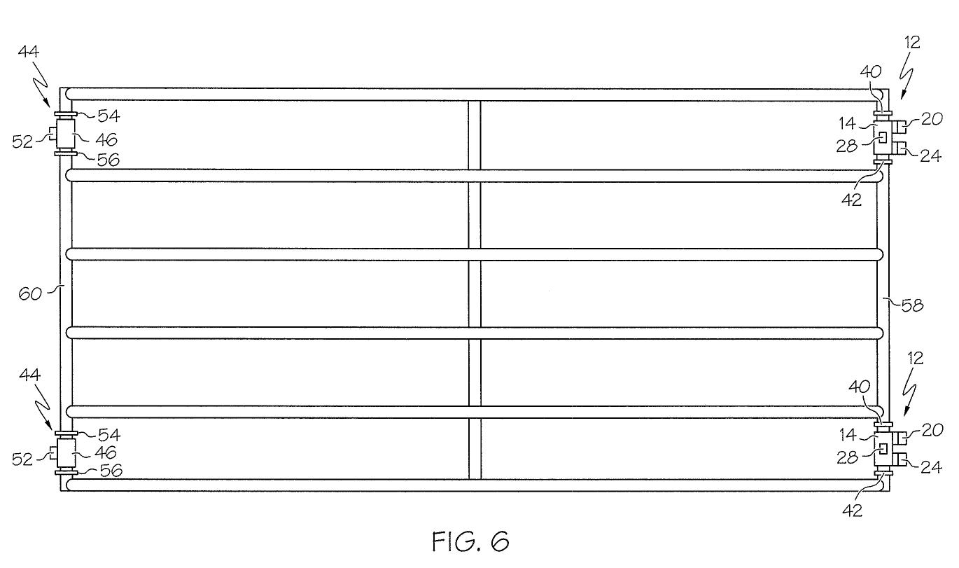

As illustrated in FIG. 6, the sleeve 44 is pivotally coupled to the panel end post 60 and stops 54, 56 are provided to restrict the longitudinal movement of the second connection assembly 44. These stops 54, 56 perform the same function as the stops 40, 42 that are used in conjunction with the first connection assembly 12. One stop 54 is secured to the second panel end post 60 proximate the sleeve first end 48. The other stop 56 is secured to the second panel end post 60 proximate the sleeve second end 50. Again, the stops 54, 56 may be selected from the group comprising of bolts, pins, clamps, rings, tabs, combinations thereof, or any other stop suitable for the present invention now known or hereafter developed. The stops 54, 56 shown in FIG. 6 are retaining rings that can be welded to the panel end post 60.

As illustrated in FIG. 5 and explained above, one embodiment of the panel connection system 10 has two rotational axes', labeled as A-A and B-B. The first connection assembly 12 is operable to rotate on the first panel end post 58 about axis A-A. When the first connection assembly 12 is rotated about axis A-A, this causes axis B-B to move in an arced path that is fixed distanced from axis A-A. The second connection assembly 44 is operable to rotate with respect to the first connection assembly 12 about axis B-B. The conjunction of these two axis', A-A and B-B, allows one panel to be folded back flat against another panel.

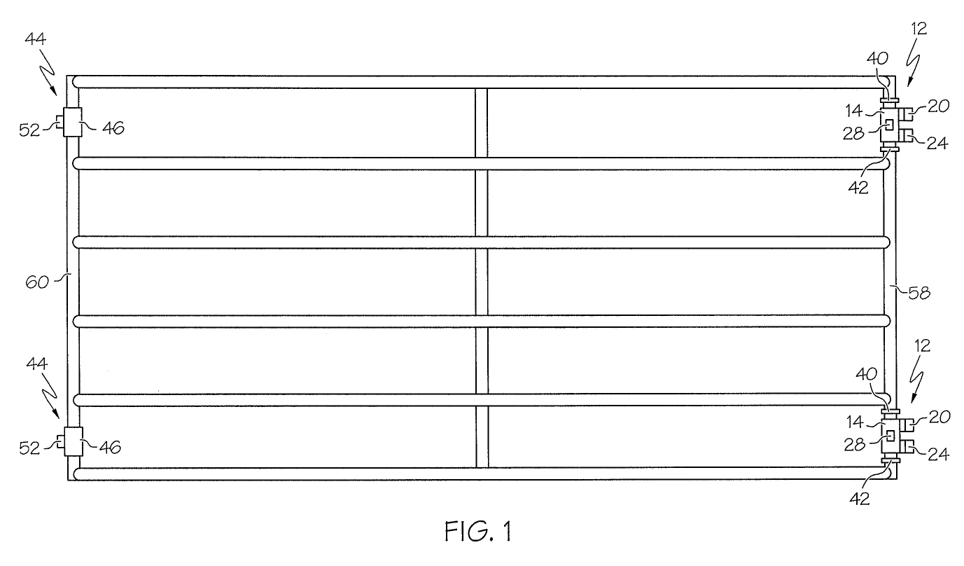

The panel connection system 10 allows two panels to be connected together in a manner in which they are angularly offset from one another such that they can conform to uneven terrain. Two connected panels can be placed on sections of ground having different slopes while each panel remains substantially parallel to their respective sections of ground. For example, one panel could be placed on a horizontal section of ground while the other panel is placed on an upward sloping section of ground. In order to allow two connected panels to become angularly offset, the connection assemblies 12, as shown in FIG. 1, are rotated in opposite directions. When the upper connection assembly 12 is radially displaced in a clockwise orientation and the lower connection assembly 12 is radially displaced in a counterclockwise orientation, or vice versa, the two connected panels can be angularly offset from one another. In order for the panels to become angularly offset, there must be a slight bit of “play” where the connection assemblies 12 are coupled to the end post 58 and/or where the connecting members 20, 24 are pinned to connecting member 52.

As illustrated in FIGS. 1 and 6, a panel can include two first connection assemblies 12 coupled to one end post 58 and two second connection assemblies 44 coupled to the other end post 60. In another embodiment, a panel can include two first connection assemblies 12 coupled to one end post 58 and two first connection assemblies 12 coupled to the other end post 60. In addition to being joined to each other, the connection assemblies 12, 44 can also be used to connect to connecters of panels that do not utilize the panel connection system 10 of the present invention.

From the foregoing, it may be seen that the panel connection system of the present invention is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

1. A panel connection system comprising:
a first connection assembly configured to be pivotally coupled to a first panel end post, said first connection assembly including a sleeve having a first end and a second end, a first connecting member coupled to said sleeve proximate said first end, a second connecting member coupled to said sleeve proximate said second end, a third connecting member coupled to said sleeve proximate said first end, and a fourth connecting member coupled to said sleeve proximate said second end, wherein said first connecting member is substantially aligned with said second connecting member and said third connecting member is substantially aligned with said fourth connecting member and radially offset from said first and second connecting members;
a second connection assembly configured to be coupled to a second panel end post having a fifth connecting member; and
a means for pivotally coupling said first and second connecting members of said first connection assembly with said fifth connecting member of said second connection assembly.

2. The panel connection system of claim 1, wherein said first connection assembly sleeve has a substantially circular cross-section.

3. The panel connection system of claim 1, wherein said first, second, third and fourth connecting members are coupled to said first connection assembly sleeve via spacers.

4. (canceled)

5. The panel connection system of claim 1, wherein said third and fourth connecting members are radially offset from said first and second connecting members by approximately 90 degrees.

6. (canceled)

7. (canceled)

8. (canceled)

9. The panel connection system of claim 1, further comprising a sixth connecting member coupled to said first connection assembly sleeve between said first and second ends wherein said sixth connecting member is radially offset from said first, second, third and fourth connecting members.

10. The panel connection system of claim 9, wherein said sixth connecting member is radially offset from said first and second connecting members by approximately 180 degrees.

11. The panel connection system of claim 1, further comprising first and second stops configured to be secured to a first panel end post wherein said first stop is proximate said first connection assembly sleeve first end and said second stop is proximate said first connection assembly sleeve second end.

12. The panel connection system of claim 1, said second connection assembly further comprises a sleeve having a first end and a second end wherein said fifth connecting member is coupled to said second connection assembly sleeve.

13. The panel connection system of claim 12, wherein said second connection assembly sleeve is pivotally coupled to said second panel end post.

14. The panel connection system of claim 13, wherein said second connection assembly sleeve has a substantially circular cross-section.

15. The panel connection system of claim 13, further comprising third and fourth stops secured to said second panel end post wherein said third stop is proximate said second connection assembly sleeve first end and said fourth stop is proximate said second connection assembly sleeve second end.

16. The panel connection system of claim 1, wherein said means for pivotally coupling said connecting members of said first connection assembly with said connecting member of said second connection assembly is a pin.

17. A panel connection system comprising:
a vertical end post having a first end and a second end;
at least two horizontal panel members attached to said vertical end post;
a first connection assembly having sleeve and first, second, third and fourth connecting members coupled to said sleeve wherein said first and second connecting members are substantially aligned with one another and said third and fourth connecting members are substantially aligned with one another and radially offset from said first and second connecting members;
a second connection assembly having sleeve and first, second, third and fourth connecting members coupled to said sleeve wherein said first and second connecting members are substantially aligned with one another and said third and fourth connecting members are substantially aligned with one another and radially offset from said first and second connecting members;
wherein said first and second connection assemblies are pivotally coupled to said vertical end post proximate said first and second ends, respectively; and
wherein said connecting members of said first and second connection assemblies are configured to be pivotally coupled to connectors of an adjoining panel.

18. The panel connection system of claim 17, wherein each of said connection assemblies further comprise a fifth connecting member coupled to said sleeve wherein said fifth connecting member is radially offset from said first, second, third and fourth connecting members.

19. The panel connection system of claim 18, wherein each of said connection assemblies further comprise a sixth connecting member coupled to said sleeve wherein said sixth connecting member is radially offset from said first, second, third, fourth and fifth connecting members.

20. A portable panel comprising:
first and second panel end posts;
a first connection assembly pivotally coupled to said first panel end post, said first connection assembly including a sleeve having a first end and a second end and two pairs of connecting members wherein a first connecting member from each pair is coupled to said sleeve proximate said sleeve first end and a second connecting member from each pair is coupled to said sleeve proximate said sleeve second end and wherein said first connecting member of each pair is substantially aligned with said second connecting member of the same pair;
a second connection assembly having a connecting member coupled to said second panel end post; and
wherein said connecting members are configured to be pivotally coupled to connectors of an adjoining panel.

21. The portable panel of claim 20, wherein said first connection assembly further comprises a fifth connecting member coupled to said sleeve between said first end and said second end and radially offset from both said pairs of connecting members.

22. (canceled)

23. A connection assembly configured to be pivotally coupled to a post, said connection assembly comprising:
a sleeve having a first end and a second end;
a first connecting member coupled to said sleeve with a spacer proximate said first end;
a second connecting member coupled to said sleeve with a spacer proximate said second end;
a third connecting member coupled to said sleeve between said first and second ends; and
wherein said first connecting member is substantially aligned with said second connecting member and third connecting member is radially offset from said first and second connecting members by approximately 90 degrees.
